(19) United States
(12) Patent Application Publication
(10) Pub. No.: US 2026/0297853 A1
(43) Pub. Date: Oct. 1, 2026

(54) MANUFACTURING METHOD OF DOUBLE PLA PRINTED PAPER CUP

(71) Applicant: LEONG LTD, Edinburgh (GB)

(72) Inventor: ARRON HARPER, Edinburgh (GB)

(21) Appl. No.: 19/091,151

(22) Filed: Mar. 26, 2025

(51) Int. Cl. D21H 19/12; B31B 50/74; B31B 120/00; D21H 19/84

(52) U.S. Cl. CPC D21H 19/12; B31B 50/747; D21H 19/84; B31B 2120/00

(57) ABSTRACT

The present invention discloses a manufacturing method of double PLA coated paper cups, the prepared clear transparent viscous liquid is poured into the heating tank, a layer of PLA is stirred and rolled up by the adhesive wheel arranged above the heating groove, and the temperature of the adhesive wheel is controlled at 190-200° C., the comma scraper arranged on the side of the adhesive wheel scrapes the PLA rolled up by the adhesive wheel to a thickness of 4~15 μ, the PLA printed paper of the present invention does not need to be soaked in the PLA solution, the adhesive wheel and the oven need electricity in the production process of the paper cup, the liquid will not penetrate into the inner wall of the paper cup by the outer wall of the paper cup, the waste paper cup can be completely decomposed into CO2 and H2O.

### TECHNICAL FIELD

The present invention relates to a method for preparing renewable raw materials from plant cellulose, in particular a manufacturing method of a double PLA printed paper cup.

### BACKGROUND

Paper pulp is processed from certain plants as raw materials, it is the basic raw material for papermaking. Plants that are commonly used as raw materials for pulping can be divided into four categories: stem fibers, bast fibers, seed hair fibers, and wood fibers. Among them, wood fibers are the most important. At present, China's wood resources are far from meeting the needs of the growing pulp and paper industry, in order to make up for the lack of raw materials, pulp products must import a considerable amount of pulp from abroad every year. The main importing countries are the United States, Canada, and Brazil.

Traditional pulping refers to the use of chemical, mechanical or a combination of the two, so that plant fiber raw materials dissociated into color or bleached pulp production process. This process is prone to the production of large amounts of chemicals, accompanied by the generation of exhaust gases and waste liquids. The accumulation of disposable cups/food packaging materials required a lot of manpower and financial resources to deal with.

In recent years, sugarcane is a plant used to produce sucrose, straw is the residue of sugarcane after extracting sucrose, straw is grayish-yellow to pale green, it is a mixture of hygroscopic mixtures containing both hard fibers and soft parenchyma (cane pith). Straw is an inexhaustible renewable resource with concentrated sources and large outputs. The world produces 5.4 million tons of straw per year. China is the world's third largest sugarcane planting country after Brazil and India, China has a number of provinces to grow sugarcane, Guangxi has become China's largest sugar-producing area. In the 2004-2005 crushing season, sugarcane production reached 41.8 million tons, sugar production reached 5.316 million tons, accounting for 58% of the national output, and the annual output of pulp and dry straw was about 4 million tons. Straw contains 30-50% cellulose, which is a linear polymer composed of cellulose disaccharide repeat units connected by β-1,4-D-glycosidic bonds, and the conversion of natural cellulose into energy or chemicals such as alcohol has become an increasingly hot topic of current research.

### SUMMARY

The present invention provides a method of making paper from straw and a fully degradable paper cup made thereof to solve the above problems in the prior art, and its practical efficiency, low cost and simple technology.

To achieve the above purposes, the present invention is achieved by the following technical solutions:

The manufacturing method of a double PLA printed paper cup, wherein the method comprises the following steps:
S1: Select the pure PLA (granular) on the market, and mix PLA (granular) with pure water (wherein weight ratio is: water ratio PLA=10:1), to prepare a mixed liquid;
S2: The mixed liquid prepared by step S1 stirred at a stirring speed of 40~55/min, stirring time of 8-12 hours, to obtain a clear transparent viscous liquid;
S3: the clear transparent viscous liquid prepared by step S2 is poured into the heating tank, the temperature of the heating tank is controlled at 200-210° C., stirred by the adhesive wheel that is set above the heating groove and rolls up a layer of PLA, the temperature of the adhesive wheel is controlled at 190-200° C., the comma scraper arranged on one side of the adhesive wheel scrapes the PLA rolled up by the adhesive wheel to a thickness of 4~15μ, the pressure wheel presses the paper to fit with the adhesive wheel, at this time the PLA rolled up by the adhesive wheel is printed with the paper (intermolecular linkage), and finally the paper that has been printed with PLA is taken away by the rotating wheel to prepare the paper coated with PLA on one side;
S4: The PLA coated paper prepared by step S3 is dried in an oven at 67~73° C., and the paper printed with a single side of the PLA coating is prepared dry;
S5: The dry single-sided PLA printed paper prepared by step S4 as raw material, made of different specifications of single-sided PLA printed paper cups.

The present invention is further set to the fact that the adhesive wheel and the pressure wheel are the same diameter, the speed is 40-60 r/min, the direction of rotation is opposite (one is clockwise, one is counterclockwise).

The present invention is further set to, the paper cup only inner layer single-sided coating PLA, PLA thickness of 28~32 gsm, the outer layer of the paper cup by this process printing PLA, thickness of 5-18.75 gsm.

The present invention is further set to the paper cup production process only heating trough, adhesive wheels, forming machine, and ovens require electricity, others do not require electricity.

The present invention is further set to, the S4 step to obtain dry single-sided PLA printed paper, wherein the uncoated PLA side of the paper, by repeating the step S3, S4, to obtain dry double-sided PLA printed paper.

The present invention is further set up to be claimed claim 5 to obtain dry double-sided PLA printed paper as raw material, made of double-sided PLA printed paper cups of different specifications.

The present invention is further set to that the paper cup can be completely decomposed into CO2 and water.

The beneficial effects of the present invention are:
1. The present invention of PLA printed paper does not need to be soaked in PLA solution;
2. PLA printed paper and PLA is connected by intermolecular force, fibers penetrate each other, bond firmly, will not delamination;
3. Paper cup only inner layer by the traditional process coated PLA, PLA thickness of 28-32 gsm, paper cup outer layer by this process for coating PLA, thickness of 5-18.75 gsm; (if both the inner and outer layers are printed by this process, the cost is lower)
4. Whether it is a hot drink or a frozen paper cup made using the process, the inner and outer walls of the paper cup are not hung with water;
5. The paper cup density is excellent, the liquid will not penetrate into the inner wall of the paper cup by the outer wall of the paper cup, and the paper cup is softened;
6. The paper cup is particularly suitable for frozen use;
7. The paper cup is made in the process only heating trough, adhesive wheel, forming machine, and oven need electricity, others do not need electricity, 1 hour requires 40 kw, the traditional 1 hour requires 80 kw, so this process saves electricity.

### BRIEF DESCRIPTION OF DRAWINGS

FIG. 1 is a schematic diagram of the machining structure of the present invention.

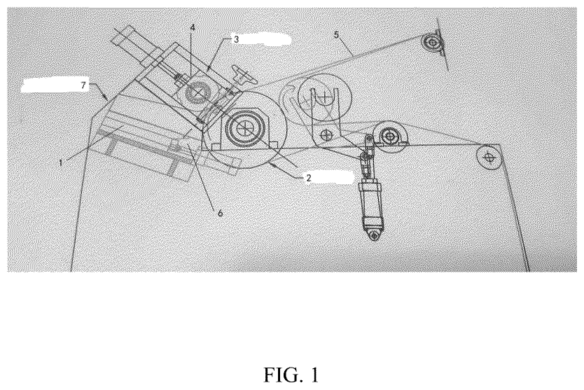

wherein, 1—heating trough; 2—adhesive wheel; 3—comma scraper; 4—pressure wheel; 5—PLA coated paper; 6—liquid; 7—PE baffle plate.

### DESCRIPTION OF EMBODIMENTS

The following in conjunction with the accompanying drawings and specific embodiments further illustrate the technical solution of the present invention, the embodiments can not be understood as a restriction on the technical solution.

### Embodiment 1

S1: Select the market pure PLA (granular) 200 g, water 2000 g, the PLA (granular) mixed with pure water, to obtain a mixed liquid;
S2: The mixed liquid prepared by step S1 is stirred at a stirring speed of 45 r/min, stirring time is 8-12 hours, and the liquid is prepared 6;
S3: the liquid 6 prepared by step S2 is poured into the heating groove 1, the heating groove 1 is arranged in the PE baffle plate 7, the temperature of the heating groove 1 is controlled at 200-210° C.,, stirring and rolls up a layer of PLA by the adhesive wheel 2 that is arranged above the heating groove 1, the temperature of the adhesive wheel 2 is controlled at 190-200° C.,, the comma scraper 3 that is arranged on the side of the adhesive wheel 2 rolls up the PLA scrape to thickness of 4-15μ, pressure wheel 4 presses paper to fit with adhesive wheel 2, the PLA rolled up by adhesive wheel 2 carries out coating (intermolecular connection) with paper at this moment, and finally the paper that has been PLA coated is taken away by the auto-rotating wheel, and the paper 5 of PLA coated is prepared;
S4: The PLA printed paper prepared in step S3 is dried in an oven at 70° C. to prepare a dry single-sided PLA-printed paper
S5: The dry single-sided PLA printed paper prepared by step S4 as raw material, made of different specifications of single-sided PLA printed paper cups.
S6: The paper cup prepared by step S5 in the compost environment for 120 days, the paper cup can be completely burned to generate CO₂ and H₂O.

Summary: Experimental data show that paper cups made of PLA printing, with environmental protection, in a composting environment for 120 days, paper cups can be completely burned to generate CO₂ and H₂O. And it also has other beneficial effects:
1: the present invention of PLA printed paper does not need to be soaked in PLA solution;
2: PLA printed paper and PLA are connected by intermolecular force, fibers penetrate each other, bond firmly, will not delamination;
3: Paper cup only inner layer by traditional process coating PLA, PLA thickness of 28-32 gsm, paper cup outer layer by this process for printing PLA, thickness of 5-18.75 gsm; (If both the inner and outer layers are coated by this process, the cost is higher)
4: Whether it is a hot drink or a frozen paper cup made using the process, the inner and outer walls of the paper cup are not hung with water;
5: The paper cup density is excellent, the liquid will not penetrate into the inner wall of the paper cup by the outer wall of the paper cup, and the paper cup is softened;
6: the paper cup is particularly suitable for refrigeration;
7: The paper cup is made in the process of only heating troughs, adhesive wheels, forming machine, and ovens need electricity, others do not require electricity, 1 hour requires 40 kw, the traditional 1 hour requires 80 kw, so this process saves electricity.

### Embodiment 2

S1: Select the market pure PLA (granular) 400 g, water 4000 g, the PLA (granular) mixed with pure water, to obtain a mixed liquid;
S2: The mixed liquid prepared by step S1 is stirred at a stirring speed of 50 r/min, stirring time is 8-10 hours, and liquid 6 is obtained;
S3: the liquid 6 prepared by step S2 is poured into the heating tank 1, the temperature of the heating groove 1 is controlled at 200-210° C., stirring and rolling up a layer of PLA by the adhesive wheel 2 that is arranged above the heating groove 1, the temperature of the adhesive wheel 2 is controlled at 190-200° C., the comma scraper 3 that is arranged on the side of the adhesive wheel 2 scrapes the PLA that the adhesive wheel 2 rolls up to a thickness of 4~15u, the pressure wheel 4 presses the paper to fit with the adhesive wheel 2, the PLA that the adhesive wheel 2 rolls up at this moment is printed with the paper (intermolecular linkage), and finally the paper that has been printed with PLA is taken away by a spinning wheel, and the paper coated with PLA 5 is prepared;
S4: The paper that is printed with PLA printed film prepared by step S3 is dried in an oven at 72° C., and the paper printed with a single side of the PLA printing is prepared dry;
S5: The dry single-sided PLA printed paper prepared by step S4 as raw material, made of single-sided PLA printed paper cups of different specifications.
S6: the paper cup prepared by step S5 in the compost environment for 120 days, the paper cup can be completely burned to generate CO₂ and H₂O.

Summary: Experimental data show that paper cups made of PLA printing, with environmental protection, in a compost environment for 120 days, paper cups can be completely burned to produce CO₂ and H₂O. And it also has other beneficial effects:
1: the present invention of PLA printed paper does not need to soak in PLA solution;
2: PLA printed paper and PLA are connected by intermolecular force, fibers penetrate each other, bond firmly, will not delamination;
3: Paper cup only inner layer by traditional process coated PLA, PLA thickness of 28-32 gsm, paper cup outer layer by this process for printing PLA, thickness of 5-18.75 gsm; (If both the inner and outer layers are coated by this process, the cost is lower)
4: Whether it is a hot drink or a frozen paper cup made using the process, the inner and outer walls of the paper cup are not hung with water;
5: The paper cup density is excellent, the liquid will not penetrate into the inner wall of the paper cup by the outer wall of the paper cup, and the paper cup is softened;
6: The paper cup is particularly suitable for refrigeration; the paper cup is particularly suitable for refrigeration;
7: the paper cup in the production process only heating trough, adhesive wheel, forming machine, and oven need electricity, others do not need electricity, 1 hour requires 40 kw, the traditional 1 hour requires 80 kw, so this process is power-saving.

The above technical solution only reflects the preferred technical solution of the present invention, some changes that may be made by those skilled in the art of the art to some parts of it are embodied in the principle of the present invention, which falls within the scope of protection of the present invention.

1. A manufacturing method of a double-PLA printed paper cup, wherein the method comprises the following steps:
S1, select pure PLA, PLA is granular, mix PLA with pure water, and a weight ratio of PLA to pure water is 10:1 to prepare a mixed liquid;
S2, stirring the mixed liquid prepared in step S1 at a stirring speed of 40~55 r/min, and a stirring time is 8-12 hours, to prepare a clear transparent viscous liquid;
S3, the clear transparent viscous liquid prepared in step S2 is poured into a heating tank, the temperature of the heating tank is controlled at 200-210° C., a layer of PLA is stirred and rolled up by an adhesive wheel arranged above the heating tank, and the temperature of the adhesive wheel is controlled at 190-200° C.; a comma scraper arranged on one side of the adhesive wheel scrapes the PLA rolled up by the adhesive wheel to a thickness of 4~15μ, a pressure wheel presses a paper to fit with the adhesive wheel, the PLA rolled up by the adhesive wheel is printed with the paper through intermolecular connection at this moment, and finally the paper that has been printed by PLA is taken away by an auto-rotating wheel, and the paper printed with PLA on one side is prepared by the auto-rotating wheel;
S4, the PLA printed paper prepared in step S3 is dried in an oven at 67~73° C. to prepare a dry single-sided PLA printed paper;
S5, the dry single-sided PLA printed paper prepared in step S4 is used as raw material to make single-sided PLA printed paper cups of different specifications;
wherein diameters of the adhesive wheel and the pressure wheel are the same, a rotation speed is 40-60 r/min, and rotation directions of the adhesive wheel and the pressure wheel are opposite.

2. (canceled)

3. The manufacturing method of a double-PLA printed paper cup according to claim 1, wherein an inner side of the paper cup layer is coated with PLA with a thickness of PLA of 28~32 gsm, and an outer side of the paper cup is printed with PLA with a thickness of 5-18.75 gsm.

4. The manufacturing method of a double-PLA printed paper cup according to claim 1, wherein the heating tank, the adhesive wheel, forming machine, and the oven are required in the process of making the paper cup.

5. The manufacturing method of a double-PLA printed paper cup according to claim 1, wherein the dry single-sided PLA printed paper prepared in the S4 step, wherein the paper on an uncoated PLA side is prepared by repeating the step S3 to obtain a dry double-sided PLA printed paper.

6. The manufacturing method of a double PLA printed paper cup according to claim 5, wherein the dry double-sided PLA printed paper prepared by claim 5 is used as a raw material to make double-sided PLA printed paper cups of different specifications.

7. The manufacturing method of a double-PLA printed paper cup according to claim 1, wherein the paper cup can be completely decomposed into CO₂ and water.
